(19) United States
(12) Patent Application Publication
(10) Pub. No.: US 2008/0037583 A1
(43) Pub. Date: Feb. 14, 2008

(54) Unified management policy for multiple format electronic communications

(75) Inventors: Adam S. Dawes, San Carlos, CA (US); Scott M. Petry, Palo Alto, CA (US); Peter K. Lund, San Francisco, CA (US); Donald R. Woods, Los Altos, CA (US); Joseph J. Green, San Francisco, CA (US); Roderick J. McChesney, Redwood City, CA (US); Ninh C. Mai, Redwood City, CA (US)

Correspondence Address: BAKER & MCKENZIE LLP;PATENT DEPARTMENT, 2001 ROSS AVENUE, SUITE 2300, DALLAS, TX, 75201, US

(73) Assignee: POSTINI, INC., San Carlos, CA (US)

(21) Appl. No.: 11/688,804

(22) Filed: Mar. 20, 2007

Related U.S. Application Data
(60) Provisional application No. 60/821,957, filed on Aug. 9, 2006.
(60) Provisional application No. 60/871,074, filed on Dec. 20, 2006.

(51) Int. Cl. H04J 3/16

(52) U.S. Cl. 370/467

(57) ABSTRACT

Disclosed herein are systems and methods for applying unified management policies to monitor, store, search and otherwise manage electronic communications, no matter what format those electronic communications take. Such unified management policy or policies are based on an integrated true identity of a user, typically a person. In one embodiment, a policy implementation module for managing electronic communications transmitted across a communications network in multiple communication formats is provided. The module comprises a message filtering process configured to uniformly filter electronic communications transmitted in the multiple communication formats and that are determined to be associated with a true identity of user employing the multiple communication formats. The filtering is done in accordance with unified management policies, and the policy implementation module further comprises a message disposition process configured to uniformly dispose of the filtered electronic communications in accordance with the unified management policies.

### CROSS-REFERENCE TO RELATED APPLICATIONS

This application claims priority to U.S. provisional patent application No. 60/821,957, filed Aug. 9, 2006, and U.S. provisional patent application No. 60/871,074, filed Dec. 20, 2006, both of which are commonly assigned with the present application and hereby incorporated by reference into the present application in their entirety. In addition to the above provisional applications, the following co-pending and commonly assigned U.S. patent application has been filed on the same date as the present application. The following application is accordingly also a related application, and is hereby incorporated herein by reference in its entirety: U.S. Ser. No. 11/688,837, Attorney Docket No. PST-013, by Peter K. Lund et al., and entitled “Synchronous Message Management System.”

### TECHNICAL FIELD

Disclosed embodiments herein relate generally to systems for monitoring and managing electronic communications, and more particularly to systems and methods for a unified management policy applicable for multiple format electronic communications and based on the identity of a user of those formats of electronic communications.

### BACKGROUND

The adoption of e-mail has occurred at an unprecedented pace. Of routine computer users, most now have at least one e-mail address, and many have more than one e-mail address, e.g., one for work and another for home. This is because e-mail offers unparalleled convenience for written communications. In addition, modern communications have continued to evolve, and have unfolded a number of other formats of electronic communication. For example, instant messaging (IM) has continued to gain popularity worldwide over the past several years. Also, more recent technologies such as voice-over Internet protocol services (VoIP) continue to find favor among the increasing number of technology-savvy people around the world.

Since the onset of electronic communications, most notably e-mail, offensive traffickers, or “spammers,” have continued a nonstop onslaught of email addresses across the globe. In addition, destructive programs, such as viruses and worms, have bombarded the same accounts. As technology continues to bring us new and convenient means of electronic communication, such offensive and detrimental attacks have now expanded into these new realms. Compounding the problem is the continued increase in the number of electronic communication accounts and services employed by the average user. As a result, a user employing, for example, two e-mail accounts, two IM accounts, and a VoIP network in his home can suffer from such unwanted and destructive attacks in any or all of these accounts.

While message filtering and other types of protection services have become more widespread and affordable, a user employing many different communication accounts and services is faced with having to purchase or maintain such protection services for each of his formats of electronic communication. In addition to the accumulated expense of obtaining such multiple services, the upkeep and monitoring of multiple services, each with their own interface, settings, options, etc., has become tedious and time consuming to say the least. On the other side of the coin, the expense and difficulties faced by organizations interested in monitoring both incoming and outgoing communications for a large number of employees are even many times greater that those faced by the individual user. Still further exacerbating the situation is the fact that many employees access their non-work communication accounts, such as their private e-mail account(s), at work to communication with friends, family, etc. The monitoring of these additional accounts, particularly since users often use different usernames, screen names, handles, aliases, etc. with their multiple accounts, has become extremely difficult, if not impossible. Accordingly, what is need is a filtering and protection approach employable for multiple electronic communication formats employed by users, even under varying usernames, handles, etc., that does not suffer from the deficiencies of conventional services.

### SUMMARY

Disclosed herein are systems and methods for applying unified management policies to monitor, store, search and otherwise manage electronic communications, no matter what format those electronic communications take. Such unified management policy or policies are based on an integrated true identity of a user, typically a person. Thus, a user's multiple means by which they send and receive electronic communications may be managed by unified policies or rules. Examples include electronic mail (e-mail) messages, instant messaging (IM) messages, and voice-over-Internet Protocol (VoIP) conversations.

In one embodiment, a policy implementation module for managing electronic communications transmitted across a communications network in multiple communication formats is provided. Such a module may comprise a message filtering process configured to uniformly filter electronic communications transmitted in the multiple communication formats and that are determined to be associated with a true identity of user employing the multiple communication formats. In these embodiments, the filtering is done in accordance with unified management policies. In addition, the policy implementation module may further comprise a message disposition process configured to uniformly dispose of the filtered electronic communications in accordance with the unified management policies.

In another embodiment, a method of managing electronic communications transmitted across a communications network in multiple communication formats is provided. Such a method may comprise intercepting multiple electronic communications transmitted across the network in corresponding ones of the multiple communication formats, and determining certain ones of the intercepted electronic communications that are transmitted in the multiple communication formats to be associated with a true identity of user employing the multiple communication formats. Such a method may further comprise filtering the certain ones of the electronic communications uniformly in accordance with unified management policies, and then disposing of the certain ones of the filtered electronic communications uniformly in accordance with the unified management policies.

In yet another embodiment, a system for uniformly managing electronic communications transmitted across a communications network in multiple communication formats is provided. Such a system may comprise an intermediate service configured to intercept multiple electronic communications transmitted across the network in corresponding ones of the multiple communication formats. The system may further comprise a policy implementation module configured to receive certain ones of the intercepted communications that are associated with a true identity of a user employing the multiple communication formats. In such embodiments, the policy implementation module is further configured to apply management policies uniformly to the certain ones of the intercepted communications associated with the user.

In still a further embodiment, another method of managing electronic communications transmitted across a communications network in multiple communication formats is provided. This method may comprise intercepting multiple electronic communications transmitted across the network in corresponding ones of the multiple communication formats. In addition, the method may comprise receiving certain ones of the intercepted communications in a policy implementation module, where the certain ones are associated with a true identity of a user employing the multiple communication formats. Such a method may also include applying management policies uniformly to the certain ones of the intercepted communications associated with the user using the multiple communication formats.

### BRIEF DESCRIPTION OF THE DRAWINGS

Embodiments are illustrated by way of example in the accompanying figures, in which like reference numbers indicate similar parts, and in which:

FIG. 1 illustrates a block diagram of one embodiment of a system for applying unified management policies in accordance with the disclosed principles;

FIG. 2 illustrates an exemplary embodiment of a system for implementing unified management policies for multiple format electronic communications in accordance with the disclosed principles;

FIG. 3 illustrates a functional block diagram, when viewed in conjunction with FIG. 2, having a more detailed view of exemplary unified management policies implemented in accordance with the disclosed principles; and

FIG. 4 illustrates a flow diagram of one embodiment of a process applying unified management policies on a user's electronic communications in accordance with the disclosed principles.

### DETAILED DESCRIPTION

The disclosed principles provide systems and methods for applying a unified policy to monitor, store, search and manage electronic communications, no matter what format those electronic communications take. Such unified management policy or policies are based on an integrated identity of a user, typically a person. In today's high-tech world, people typically have multiple means by which they send and receive electronic communications. Examples of electronic communication envisioned by the disclosed principles include, but are not limited to, electronic mail (e-mail), instant messaging (IM), and voice-over-Internet Protocol (VoIP), web information retrieval or exchange (e.g., web surfing, automated distribution such as podcasts, etc., and web distribution such as blogs and RSS distribution, etc.), file transfers, presence information, and video-over-IP communications.

In addition, among these various means of electronic communication, many people maintain multiple accounts for each means of communication, such as two or three e-mail accounts (with corresponding multiple e-mail addresses), two or three IM services, etc. Typically, the user would have a distinct ‘username,’ ‘screen name,’ ‘handle,’ e-mail ‘address’ or e-mail ‘alias’ for each account. In addition, a user also may have an IP address, a device ID number (such as associated with a mobile phone), and a telephone number associated with his identity. Thus, for all of the universe of electronic identifiers, identities or ‘handles’ that a typical user may have in the virtual world, the disclosed principles provide a technique for tying together all of the various ways the same user may be identified across any means for electronic communication, and then layering on top of that collection unified management policies for filtering, surveillance, controlling, archiving, encryption, etc. all of the various electronic communications. These policies would manage all of the various electronic communications by being tied to the true identity of the user.

As used herein, “true identity” means a single selected identity of a user, whether a person or entity, engaging in electronic communications of any format, either now existing or later developed, using one or more electronic identifiers, names, handles, or other means of format- or account-specific identification when engaging in such communications, but is not intended to be limited to a person's or entity's legal or otherwise official name or designation. As such, a user's “true identity” for purposes of the disclosed principles may actually be an alias or other specific means of identifying that particular user, rather than his/her or its legally given name.

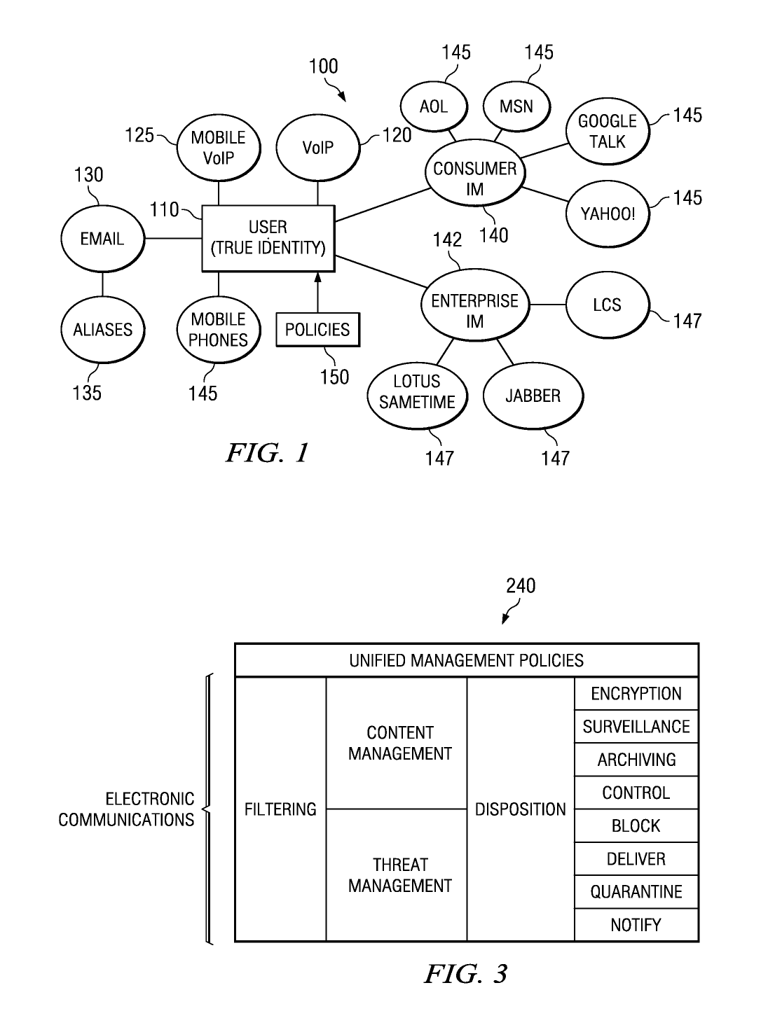

FIG. 1 illustrates a block diagram of one embodiment of a system 100 for applying unified management policies in accordance with the disclosed principles. Specifically, the system 100 includes a user 110 that has an identity associated with him (or it). The user 110 has only a single true identity associated with him, even though the user 110 may employ multiple formats for sending and receiving electronic communications where his true identity is not openly employed with these services. In the illustrated example, the user 110 may be employing VoIP services 120, e-mail services 130, and consumer IM services 140 and enterprise IM services 142, but may identify herself differently with each services, even though it is the same user 110 for all three electronic communication formats. Of course, any type of electronic communication service, such as video services and other examples listed above, may also be present.

As illustrated in FIG. 1, although the user 110 has only a single true identity associated with her, the user 110 may have a number of other aliases, screen names, usernames, or other handles or forms of identifying herself when employing one of the formats for electronic communications. Thus, the user 110 may have one or more e-mail aliases 135 she employs when sending or receiving e-mail from one or more e-mail accounts. For example, the user 110 may have a work e-mail account using the address “user@postini.com,” while also having one or more free e-mail account addresses, such as “user@yahoo.com,” “user@gmail.com,” and “user@roadrunner.com.” Even though each of these e-mail addresses is different, they are owned and employed by the same user 110; thus, the user's 110 true identity is tied to each of these addresses. Although such multiple addresses and/or aliases are employed by the user 110, because they are all associated with the same user 110 and tied to his true identity, unified management policies 150 may be employed in accordance with the disclosed principles to manage all of the electronic messages involved with any e-mail account associated with the user's 110 true identity.

As with e-mail services, the user 110 may also employ multiple IM services 140 to send and receive instant messages. In the illustrated example, the user 110 has four consumer IM services, using the specific IM services 145 of AOL®, Yahoo!®, GoogleTalk®, and MSN®. In addition, the user may have one or more enterprise IM services 142 as well, such as the illustrated specific services 147 of Microsoft Live Communication Server (LCS), Jabber®, and IBM Lotus SameTime®. As before, the user's 110 username or screen name may be different among one or more of these IM services 140, 142, and in any case each likely differs from his true identity. However, as with the various e-mail services of the user 110 discussed above, unified management policies 150 for managing all of the user's 110 instant messages may also be implemented according to the disclosed principles. As a result, all of the instant messages associated with the user's 110 true identity, regardless of which account, are managed using a single system for implementing the unified management policies. In addition to e-mail and IM electronic identifiers, the user may also have other means by which she may be identified, such as an IP address, an electronic device ID, and a telephone number.

In short, all electronic communications, regardless of format, that are tied to a user's 110 true identity may be managed using unified management polices 150. This is the case no matter what username, screen name, alias, or other means of identification that the user 110 is known by for one or more various formats of electronic communication. Thus, although such unified management policies 150 according to the disclosed principles are shown applied to a user's 110 VoIP system 120, e-mail services 130 and IM services 140, 142, these unified management policies may also be extended to any form of electronic communication employed by the user 110, such as mobile electronic devices, presence information, etc., so long as she is registered with that communications medium using the same true identity she has registered with others of the communication media illustrated in FIG. 1. For example, the unified management policies may be applied to the web (or other Internet-based) electronic communications of a user. In such embodiments, the disclosed technique for providing unified management policies may be implemented to monitor/filter/control/secure any type of electronic communications to/from the user and a website, such as text or files entered into or sent to (or received from) a website. Such communications may include HTML, XML, text entries, and even “cookies” sent from websites.

Furthermore, although the embodiment in FIG. 1 is discussed in terms of tying unified management policies 150 to the user's 110 true identity, it should be noted that the disclosed principles are not so limited. Specifically, while an advantageous embodiment of implementing unified management policies involves tying the unified policies to the user's 110 legal identity, other embodiments that tie the unified management policies to other single means of specifically identifying the user 110, but which is still tied to his selected means of electronic communications, are also envisioned. As such, a user 110 seeking anonymity may register one or more means of electronic communications using a single alias or other alternate/secret identity, and then the unified management policies disclosed herein may be applied to that ‘anonymous’ single identity. Thus, as discussed above, this single selected means of identifying the user among his various formats for electronic communication becomes his “true identity” for use with a system constructed according to the disclosed principles.

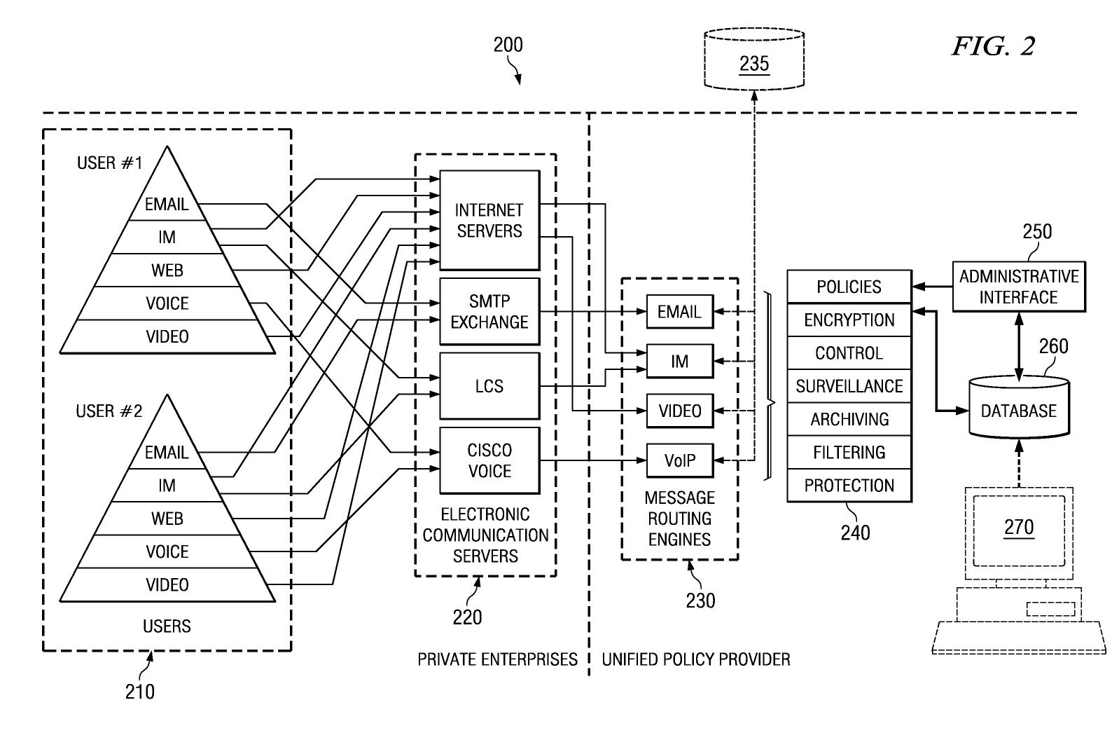

FIG. 2 illustrates a block diagram of an exemplary embodiment of a system 200 for implementing unified management policies for multiple format electronic communications in accordance with the disclosed principles. This figure illustrates the connections of equipment dedicated to implementing the disclosed unified management polices to conventional equipment used for transmitting or otherwise handling various forms of electronic communication.

In the illustrated embodiment, two separate users are shown, User #1 and User #2, and each is employing multiple formats for electronic communications. Specifically, each user has multiple user accounts 210 employing, in this illustrated example, VoIP services, IM services, video services, web-based services (e.g., web-based RSS format), and e-mails services. In addition, each user may be employing multiple addresses, aliases, handles, screen names, etc. among each of these formats of electronic communication, for example, depending on the service provider for each service. For example, each user may have three email addresses, two consumer IM screen names, one enterprise IM screen name, and two usernames for VoIP services. Although each user may be employing multiples means of identifying themselves within each communication format and service provider, each user still maintains one true identity, perhaps their true legal name, by which they may be specifically identified as the user for all of these exemplary accounts/services.

Also illustrated in FIG. 2 are electronic communication servers 220 to provide each of these exemplary formats of electronic communication. Thus, the one or more email accounts employed by each user are facilitated by SMTP exchange email servers owned and operated by private e-mail service providers. Similarly, each user's one or more IM accounts are facilitated by private dedicated equipment owned and operated by the one or more IM service providers, such as the Microsoft LCS illustrated. Likewise, each user's VoIP service(s) is facilitated by VoIP servers, such as the illustrated Cisco voice server. Moreover, one or more of the services may be carried on Internet servers, rather than dedicated servers. All of these electronic communication accounts and facilitating equipment are privately owned and implemented, and thus are illustrated in FIG. 2 as “Private Enterprises” independent of equipment constructed in accordance with the disclosed principles.

Opposite the Private Enterprises side of the system 200 shown in FIG. 2 are the equipment and techniques provided to the users 210 by a Unified Policy Provider implementing the unified management policies provided by the disclosed principles. The initial equipment employed to institute the disclosed unified management policies for each user's electronic communications are a number of message routing engines 230. As illustrated, a separate message routing engine 230 may be employed for the various formats of electronic communication, although the disclosed principles are not so limited. In this exemplary embodiment, a separate routing engine is used for each of e-mail, IM and VoIP electronic communications, as well as providing a routing engine for services carried on the Internet server(s). While the message routing engines 230 employed in the disclosed system 200 may be of conventional design and operation, one or more of these engines 230 may instead be an intermediate pre-processing server of the type disclosed in U.S. Pat. No. 6,650,890, which is commonly owned with the present disclosure and incorporated herein by reference in its entirety for all purposes. Additionally, it should be noted that FIG. 2 covers both incoming and outgoing electronic communications. More specifically, the communication servers 220 are connected to a communications network, such as the Internet, and are configured to handle the transfer of electronic communications both to and from the Unified Policy Provider. Stated another way, the equipment of the Unified Policy Provider is configured to intercept electronic communications to and from the users 210, in accordance with the principles disclosed herein.

Regardless of the type of message routing engine 230 employed, the disclosed principles provide for the interception and management of the various forms of electronic communication employed by each user based on the known (and detected) true identity of the user. More specifically, once a user's true identity is employed by the Unified Policy Provider, for example, after the user registers with the Provider for this service, then all of that user's electronic communications and messages that are identifiably tied with his true identity are intercepted by the Unified Policy Provider's routing engines 230. Once the electronic communications are intercepted, unified management policies 240 may then be applied to all of the user's electronic communications. As such, the Unified Policy Provider may apply a “unified” content manager rule to, for example, IM conversations and VoIP conversations simultaneously, without having to create and employ separate rules for each form of electronic communication. The same could occur for e-mail messages, as well as any type of electronic communication either now existing or later developed.

As used herein, “unified management policies” means a message/communication management rule that is uniformly applied across multiple electronic communications associated with the same user regardless of the format by which those communications are sent. Exemplary unified management polices illustrated in FIG. 2 include encryption, control, surveillance, archiving, filtering, and protection rules or policies that are uniformly applied on all forms of electronic communication tied to a user's true identity. Thus, the disclosed principles provide for applying a uniform policy, such as a message handling rule, message archiving strategy, or even data encryption, based on a single true identity of an individual user or even a set-up group within an organization. Moreover, a single administrative interface 250 may be used to access, set up, and modify these unified management policies. Exemplary unified management policies are discussed below with reference to FIG. 3.

To establish or modify the unified management policies, an account database 260 may be associated with the management policies 240. In the illustrated embodiment, the database 260 holds user account information for each of the users subscribing to the disclosed system 200. These user accounts could include the specific communication handling rules that comprise the unified management policies 240. Thus, the unified management policies 240 may be based on the settings in the user accounts stored in the database 260.

As mentioned above, the settings in the individual user accounts that govern the unified management polices 240 may be accessed (e.g., for modification) by either an administrator of the system 200 or even the user 210 herself. As shown, an administrator may access the user accounts in the database 260 via the administrative console 250. In some embodiments, a user 210 may directly access his user account to modify the settings therein. In these embodiments, the user may access his account via a website associated with and linked to the database 260. For example, in the illustrated embodiment, the user may access such a website via a computer terminal 270 connected to a computer network such as the Internet. Of course, other ways of accessing his user account for management thereof are also possible.

In embodiments providing user access to his account, a message center to interface with the account via the website may be provided. Thus, while the website allows the user access to his account settings for modification thereof, the message center would allow the user to access all the electronic communications she has engaged in. For example, the user could access and display all of his sent communications, all of his received communications, and all of his IM conversations, which may be stored in archiving database 235. Such message center access would be in addition to the accessibility of the user's electronic communications by a system administrator or other supervising personnel.

FIG. 3 illustrates a functional block diagram, when viewed in conjunction with FIG. 2, having a more detailed view of exemplary unified management policies implemented in accordance with the disclosed principles. Although only certain unified management policies are shown in FIG. 3, no limitation to the example policies discussed herein is intended or should be implied. Thus, any appropriate management policy of any type of electronic communication may be employed with the present disclosure.

As discussed above, as electronic messages of any type enter the systems of the Unified Policy Provider, they are “filtered” or otherwise processed in accordance with the various policies instituted on all electronic communications associated with the user's true identity. In some embodiments, these unified management policies are established by the user herself. In other embodiments, the unified management policies are not established by the user, but instead are established by someone associated with the user, such as the user's employer. In still other embodiments, the unified management policies are established by an administrator associated with the Unified Policy Provider. In many embodiments, the unified management policies may be established and maintained by a combination of any of these persons/entities, perhaps depending on the type of filtering involved.

As the incoming electronic communications are filtered, unified management policies addressing both content and threat management are employed. For threat-based filtering of electronic communications, the type of unified management policy that may be implemented in accordance with the disclosed principles addresses the protection of systems that can be damaged by electronic communications. Such filtering involves detecting and preventing threats to the user's system (or systems affiliated with the user, such as the user's employer's system) using a single uniform policy applicable to all of the different types of electronic communications associated with a user's true identity. Specifically, the protection policies may be implemented to protect against threat potentials such as viruses, worms, and other types of destructive programs, as well as spam, spyware, spim (the IM equivalent of e-mail spam), protection against objectionable content, or other similar unwanted communications.

In one example, if a threat has previously been detected from a certain email address or other type of communication associated with a specific screen name, the true identity of that sender (or recipient, as the case may be) may be used to determine and then monitor/filter all communications to/from all other aliases, accounts, handles, etc. associated with that particular user. Since that user may be using a single computer, such as his work terminal, to send messages using a certain email account, other communications involving that same computer, although perhaps not the same account, may also carry a threat to the system. Of course, any type of protection policies may be employed.

Upon filtering based on potential systemic threats, suspect electronic communications of all types may then be properly disposed of. Such communication disposition may include blocking communications, including quarantining suspect messages, “black holing” incoming communications, or simply delivering approved messages if no threat is discovered. Other types of message disposition may occur in accordance with techniques disclosed in U.S. Pat. No. 6,941,348, which is commonly owned with the present disclosure and incorporated herein by reference in its entirety for all purposes. These techniques include protection against other, less obvious threats, such as directory harvest attacks, e-mail bombs, phishing, and even more system-based attacks. The system may even notify the user of the action taken.

In addition to threat-based filtering, the disclosed unified management policies may also simultaneously filter incoming communications of all formats based on the content of the communications. Depending on the results of the content-based filtering of incoming electronic communications, the disposition of the communications may include a number of specialized types of message handling. Although distinct communication dispositions are discussed below, it should be noted that multiple dispositions of filtered electronic communications may be done. For example, in accordance with the detailed discussions below, an electronic communication may be under surveillance, encrypted, and then a copy of the communication archived for future reference in a database 235. Of course, other combinations of dispositions may also occur.

One of the types of content-based unified management policies that may be applied to all of the electronic communications of a user via his or its true identity are control policies. Such policies may involve access to a particular protocol for a particular user. In one example, a combination of content and the user could trigger a certain policy, such as whether certain protocols or applications would be activated, or whether access in general is disallowed. Specific embodiments may include intellectual property controls. Thus, electronic communications would be filtered looking for disclosures of private intellectual property matters, such as through the sending of e-mail or attachments, or perhaps even uploading information or documents to a website.

In other privacy-based embodiments for instituting control policies, electronic communications could be filtered for things like credit card numbers, social security numbers, account numbers, and the like. Thus, control policies may be based on electronic communication content, message sender, message recipient, or any combination thereof.

Another type of content-based unified management policy that may be implemented in accordance with the disclosed principles is the archiving of electronic communications. Archiving policies may be implemented by filtering incoming electronic communications based on content and/or sender/recipient of the communication. The archived communications may be in any advantageous format, such as the actual text of a text-base message (e.g., e-mails and IM messages), the voice recording of a voice-based message (e.g., VoIP communications), or it may be a transcript of a voice-based communication.

In addition, such archiving policies are also useful for searching past electronic communications that have been stored, for example, in database 235. In such embodiments, all electronic communications can be searched by identity of the user, or even by the individual aliases and handles associated with a particular user. For example, in a discovery situation, someone may want to know everything that the CFO of a particular company implementing a system as disclosed herein has been communicating. In such a situation, instead of needing to know every one of their e-mail aliases, e-mail addresses, screen names, etc. that they may have registered with AOL®, MSN®, Yahoo®, GoogleTalk®, or any other service provider, all of this user's electronic communications may be searched by a single criteria based on his true identity. Moreover, searching may be done based on communication format, if desired. Still further, such archive searching may also be permitted by the user herself, perhaps via the message center discussed above.

Thus, a search may be conducted based on the user's true identity, but also searches may be made by any of their handles, etc. and still recover all of the related electronic communications associated with that true identity. Of course, such archiving and archive searching may be done for any type of electronic communication, including VoIP and the like. Furthermore, time limitations for storing archived communications in the database 235 may also be established in order to more efficiently utilize storage space, such as storing communications for only 3 years, 5 years, or 7 years. Still further, the archived communications may even be encrypted based on message content or sender/recipient for added privacy protection, and may be for internal personnel (such as employees of a business) or for external parties. Communication encryption in accordance with the disclosed principles is discussed in further detail below.

Yet another type of content-based unified management policy that may be implemented in accordance with the disclosed principles is the surveillance of electronic communications from the multiple aliases, handles, accounts, etc. of a single user. One form of surveillance could include sending an alert to a system administrator or monitor of some sort if some condition is reached or violated. In a specific example, workflow supervision could be implemented. For example, if a trader for a Wall St. firm were the user, a rule could be established where 10% of all electronic communications from all accounts/services associated with the true identity of that user would be routed into a bucket. There, a reviewer would review the various electronic communications to determine if the user's communications have any undesirable issues or problems. Alternatively, an automated component of the system would evaluate the diverted communications. In other embodiments, the diversion of the communications themselves may be based on content, such as all communications from a particular user detected as potentially having work-related terms, etc. in the communication. Such surveillance may even extend to the surfing of the user to certain competitor websites, or even uploading any items to any website.

A further example of a content-based unified management policy that may be implemented in a system constructed as disclosed herein is the encryption of certain electronic communications. With this management policy, rules may be established to, for example, encrypt all electronic communications associated with a user's true identity. In such an embodiment, an employer could then be assured that no matter what format of electronic communication that user engages in at work, whether a private or work account, all of the communications are encrypted to protect the company's interests. In similar embodiments, all such user communications may first be evaluated by the system, and encryption of only certain communications of the user based on the results of the evaluation. Thus, encryption policies in accordance with the disclosed principles may be based on content of the communication, or the sender or recipient. Moreover, encryption policies may be implemented in conjunction with other polices, such as surveillance, archiving and control policies. Alternatively, such other policies may be implemented in combination with one or more of the others without employing encryption rules, if desired.

A further advantage of a system having unified management polices as disclosed herein is the application of uniform policies to designated groups, rather than just management communications on only an individual level. More specifically, a single user may be the member of multiple “groups” within a single organization. For example, the user may simultaneously be part of the ABC Company, but then also be a member of the Engineering Group within that company, as well as a member of the Communications Technologies Group within the Engineering Group, and then even a member of the San Carlos, Calif. Group within the company as well.

In accordance with the disclosed principles, unified management policies could then be implemented on a group basis instead of, or even in addition to, implementation on an individual basis. In such embodiments, while baseline unified management policies may be implemented for the entire ABC Company, certain additional unified management policies may be desired for one or more of the groups the user is a member of. For example, threat-based policies and archiving rules may be all that is implemented for the company as a whole, but because of the potential disclosure of sensitive intellectual property, surveillance and control policies for members of the Engineering Group may be warranted. Even in group embodiments, however, all of the unified management policies imposed on a user may still be linked to his true identity, as disclosed herein. Thus, a user who is a member of the Engineering Group in this example may still have all of his electronic communications filtered, regardless of communication format or which account the user may be employing to send a communication.

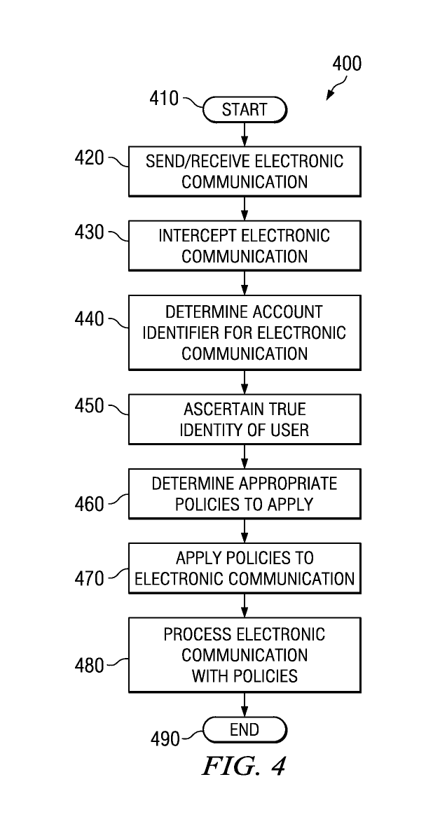

FIG. 4 illustrates a flow diagram 400 of one embodiment of a process applying unified management policies on a user's electronic communications in accordance with the disclosed principles. The process begins at a Start Block 410, where any needed equipment and software is initialized for application to appropriate electronic communications.

At Block 420, an electronic communication is sent/received by a user. Specifically, an electronic communication is sent by the user or intended for delivery to the user using a handle, email address, phone number, etc. of the user that is associated with, and appropriate for, the type of account used for the electronic communication. At Block 430, the electronic communication is intercepted by the unified management system. Specifically, an appropriate electronic communication engine is used to intercept the communication when it is either sent by or to the user. For example, if the electronic communication is an email message, then an SMTP-based engine may be used to intercept the email. To intercept the electronic communication, the engine is in communication with the specific type of server used for the electronic communication being intercepted. Thus, in this email example, the email engine of the unified message management system is in communication with the SMTP exchange server handling the email message. Of course, different servers and corresponding engines are used for other types of electronic communications.

At Block 440, after the message has been intercepted, the user is identified from the message. For example, if the email is an inbound email, the addressed recipient will be the user's email address for that particular email account. Likewise, if the user is sending an instant message, then the sender screen name will be the user's screen name used with that particular IM service. Once the account identifier being used with this particular electronic communication is determined from the communication, the true identity of the user is ascertained at Block 450. Specifically, the account identifier on the intercepted communication is cross-referenced within the unified message management system to determine the true identity of the user associated with that specific account identifier. In exemplary embodiments, user accounts, which have a listing of all of the specific account identifiers associated with each user, are stored and queried to ascertain the true identity of the user on this particular account/service.

Once the true identity of the user is ascertained, that user's preferences or settings are accessed to determine what processing, at Block 460, should be done to the electronic communication. For example, if the electronic communication is an incoming message (e.g., email, IM, etc.), the user's spam and virus filtering may be automatically applied across all such incoming messages, regardless of message format. Likewise, if the electronic communication is outgoing, then security policies, such as encryption, archiving and surveillance, may be automatically applied to the electronic communication, regardless of format. Accordingly, at Block 470, once the appropriate policy(ies) have been determined based on the user's account settings (whether established by the user or an administrator), the appropriate policy(ies) is applied to the electronic communication. Then, at Block 480, the disposition of the electronic communication is accomplished in accordance with such policy(ies). As discussed above, disposition may include blocking the electronic communication, archiving the electronic communication, encrypting the electronic communication, or even simply allowing the electronic communication to pass through to/from the user. Once the appropriate processing, if any, is accomplished on the electronic communication, the process ends at an End Block 490. In various embodiments, a fewer or a greater number of steps may be involved with a process conducted in accordance with the principles disclosed herein.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A policy implementation module for managing electronic communications transmitted across a communications network in multiple communication formats, the module comprising:
a message filtering process configured to filter electronic communications transmitted in the multiple communication formats and that are determined to be associated with a true identity of a user employing the multiple communication formats, the filtering done in accordance with unified management policies applied to the multiple communication formats; and
a message disposition process configured to dispose of the filtered electronic communications in accordance with the unified management policies.

2. A module according to claim 1, wherein the communication formats comprise e-mail format, instant message format, Voice-over-Internet Protocol format, and formats for web-based information retrieval and distribution.

3. A module according to claim 1, wherein the user is a sender of the filtered electronic communications.

4. A module according to claim 1, wherein the user is an intended recipient of the filtered electronic communications.

5. A module according to claim 1, wherein the policy implementation module is accessible by an administrator for setting or adjusting the unified management policies.

6. A module according to claim 1, wherein the policy implementation module is accessible by the user via a website for setting or adjusting the unified management policies.

7. A module according to claim 1, wherein the unified management policies are based on user accounts associated with the policy implementation module.

8. A module according to claim 1, wherein the message disposition process is further configured to store the filtered electronic communications in a database associated with the policy implementation module.

9. A module according to claim 1, wherein the unified management policies comprise unified content-based management policies.

10. A module according to claim 9, wherein the unified content-based management policies are selected from the group consisting of:
control of system access or applications;
archiving of communications;
quarantining communications;
black holing communications;
blocking delivery of communications;
notifying the user of a disposition taken on a communication;
surveillance of communications; and
encryption of outgoing communications.

11. A module according to claim 1, wherein the unified management policies comprise unified threat-based management policies.

12. A module according to claim 11, wherein the unified threat-based management policies are selected from the group consisting of:
protection against destructive applications;
protection against objectionable content; and
protection against unwanted communications.

13. A module according to claim 1, wherein the electronic communications are communications selected from the group consisting of:
electronic mail messages;
electronic mail attachments;
instant messages;
website cookies;
RSS feeds;
RSS distributions;
post to web log;
file transfers;
presence information;
Video-over-IP communications;
items uploaded to websites; and
Voice-over-IP communications.

14. A method of managing electronic communications transmitted across a communications network in multiple communication formats, the method comprising:
intercepting multiple electronic communications transmitted across the network in corresponding ones of the multiple communication formats;
determining certain ones of the intercepted electronic communications that are transmitted in the multiple communication formats to be associated with a true identity of user employing the multiple communication formats;
filtering the certain ones of the electronic communications in accordance with unified management policies; and
disposing of the certain ones of the filtered electronic communications in accordance with the unified management policies.

15. A method according to claim 14, wherein the intercepting comprises intercepting the multiple electronic communications with an intermediate service comprises routing engines corresponding to the communication formats of the intercepted electronic communications.

16. A method according to claim 14, wherein the communication formats comprise e-mail format, instant message format, Voice-over-Internet Protocol format, and formats for web-based information retrieval and distribution.

17. A method according to claim 14, wherein the user is a sender of the certain ones of the intercepted communications.

18. A method according to claim 14, wherein the user is an intended recipient of the certain ones of the intercepted communications.

19. A method according to claim 14, further comprising setting or adjusting the management policies using an administrative console associated with the policy implementation module and accessible by an administrator.

20. A method according to claim 14, further comprising setting or adjusting the management policies using a webpage associated with the policy implementation module and accessible by the user.

21. A method according to claim 14, wherein the filtering and disposing further comprise filtering and disposing of the certain ones of the electronic communications in accordance with settings for the management policies governed by user accounts stored in a database associated with the policy implementation module.

22. A method according to claim 14, wherein the disposing further comprises storing the certain ones of the electronic communications in a database associated with the policy implementation module.

23. A method according to 22, further comprising searching the stored certain ones of the electronic communications of the user based on their communication format.

24. A method according to 22, further comprising searching the stored certain ones of the electronic communications of the user based on an electronic identifier associating the user with a particular one of the multiple communication formats.

25. A method according to 24, wherein the electronic identifier is selected from the group consisting of:
a screen name;
an email address;
an IP address;
a device ID number;
a telephone number;
a username; and
a handle.

26. A method according to claim 14, wherein the management policies comprise unified content-based management policies.

27. A method according to claim 26, wherein the unified content-based management policies are selected from the group consisting of:
control of system access or applications;
archiving of communications;
quarantining communications;
black holing communications;
blocking delivery of communications;
notifying the user of a disposition taken on a communication;
surveillance of communications; and
encryption of outgoing communications.

28. A method according to claim 14, wherein the management policies comprise unified threat-based management policies.

29. A method according to claim 28, wherein the unified threat-based management policies are selected from the group consisting of:
protection against destructive applications;
protection against objectionable content; and
protection against unwanted communications.

30. A method according to claim 14, wherein the electronic communications are communications selected from the group consisting of:
electronic mail messages;
electronic mail attachments;
instant messages;
website cookies;
RSS feeds;
RSS distributions;
post to web log;
file transfers;
presence information;
Video-over-IP communications;
items uploaded to websites; and
Voice-over-IP communications.

31. A system for uniformly managing electronic communications transmitted across a communications network in multiple communication formats, the system comprising:
an intermediate service configured to intercept multiple electronic communications transmitted across the network in corresponding ones of the multiple communication formats;
a policy implementation module configured to receive certain ones of the intercepted communications that are associated with a true identity of a user employing the multiple communication formats; and
wherein the policy implementation module is further configured to apply unified management policies to the certain ones of the intercepted communications associated with the user.

32. A system according to claim 31, wherein the intermediate service comprises routing engines corresponding to communication formats of the intercepted communications.

33. A system according to claim 32, wherein the communication formats comprise e-mail format, instant message format, Voice-over-Internet Protocol format, and formats for web-based information retrieval and distribution.

34. A system according to claim 31, wherein the user is a sender of the certain ones of the intercepted communications.

35. A system according to claim 31, wherein the user is an intended recipient of the certain ones of the intercepted communications.

36. A system according to claim 31, further comprising an administrative console associated with the policy implementation module and accessible by an administrator for setting or adjusting the management policies.

37. A system according to claim 31, further comprising a webpage associated with the policy implementation module and accessible by the user for setting or adjusting the management policies.

38. A system according to claim 31, further comprising a database associated with the policy implementation module and having user accounts stored therein comprising settings for the management policies.

39. A system according to claim 31, wherein the policy implementation module is further configured to store the certain ones of the intercepted communications in a database associated with the policy implementation module.

40. A system according to 39, wherein the database is configured for searching the stored certain ones of the intercepted communications of the user based on their communication format.

41. A system according to 39, wherein the database is configured for searching the stored certain ones of the electronic communications of the user based on an electronic identifier associating the user with a particular one of the multiple communication formats.

42. A system according to 41, wherein the electronic identifier is selected from the group consisting of:
a screen name;
an email address;
an IP address;
a device ID number;
a telephone number;
a username; and
a handle.

43. A system according to claim 31, wherein the management policies comprise unified content-based management policies.

44. A system according to claim 43, wherein the unified content-based management policies are selected from the group consisting of:
control of system access or applications;
archiving of communications;
quarantining communications;
black holing communications;
blocking delivery of communications;
notifying the user of a disposition taken on a communication;
surveillance of communications; and
encryption of outgoing communications.

45. A system according to claim 31, wherein the management policies comprise unified threat-based management policies.

46. A system according to claim 45, wherein the unified threat-based management policies are selected from the group consisting of:
protection against destructive applications;
protection against objectionable content; and
protection against unwanted communications.

47. A system according to claim 31, wherein the electronic communications are communications selected from the group consisting of:
electronic mail messages;
electronic mail attachments;
instant messages;
website cookies;
RSS feeds;
RSS distributions;
post to web log;
file transfers;
presence information;
Video-over-IP communications;
items uploaded to websites; and
Voice-over-IP communications.

48. A method of managing electronic communications transmitted across a communications network in multiple communication formats, the method comprising:
intercepting multiple electronic communications transmitted across the network in corresponding ones of the multiple communication formats;
receiving certain ones of the intercepted communications in a policy implementation module, wherein the certain ones are associated with a true identity of a user employing the multiple communication formats; and
applying unified management policies to the certain ones of the intercepted communications associated with the user using the multiple communication formats.

49. A method according to claim 48, wherein the intercepting comprises intercepting the multiple electronic communications with an intermediate service comprises routing engines corresponding to the communication formats of the intercepted electronic communications.

50. A method according to claim 48, wherein the communication formats comprise e-mail format, instant message format, Voice-over-Internet Protocol format, and formats for web-based information retrieval and distribution.

51. A method according to claim 48, wherein the user is a sender of the certain ones of the intercepted communications.

52. A method according to claim 48, wherein the user is an intended recipient of the certain ones of the intercepted communications.

53. A method according to claim 48, further comprising setting or adjusting the management policies using an administrative console associated with the policy implementation module and accessible by an administrator.

54. A method according to claim 48, further comprising setting or adjusting the management policies using a webpage associated with the policy implementation module and accessible by the user.

55. A method according to claim 48, wherein the filtering and disposing further comprise filtering and disposing of the certain ones of the electronic communications in accordance with settings for the management policies governed by user accounts stored in a database associated with the policy implementation module.

56. A method according to claim 48, wherein applying management policies further comprises storing the certain ones of the intercepted communications in a database associated with the policy implementation module.

57. A method according to 56, further comprising searching the stored certain ones of the intercepted communications of the user based on their communication format.

58. A method according to 56, further comprising searching the stored certain ones of the intercepted communications of the user based on an electronic identifier associating the user with a particular one of the multiple communication formats.

59. A method according to 58, wherein the electronic identifier is selected from the group consisting of:
a screen name;
an email address;
an IP address;
a device ID number;
a telephone number;
a username; and
a handle.

60. A method according to claim 48, wherein the management policies comprise unified content-based management policies.

61. A method according to claim 60, wherein the unified content-based management policies are selected from the group consisting of:
control of system access or applications;
archiving of communications;
quarantining communications;
black holing communications;
blocking delivery of communications;
notifying the user of a disposition taken on a communication;
surveillance of communications; and
encryption of outgoing communications.

62. A method according to claim 48, wherein the management policies comprise unified threat-based management policies.

63. A method according to claim 62, wherein the unified threat-based management policies are selected from the group consisting of:
protection against destructive applications;
protection against objectionable content; and
protection against unwanted communications.

64. A method according to claim 48, wherein the electronic communications are communications selected from the group consisting of:
electronic mail messages;
electronic mail attachments;
instant messages;
website cookies;
RSS feeds;
RSS distributions;
post to web log;
file transfers;
presence information;
Video-over-IP communications;
items uploaded to websites; and
Voice-over-IP communications.
